(19) United States
(12) Patent Application Publication
(10) Pub. No.: US 2025/0148343 A1
(43) Pub. Date: May 8, 2025

(54) Matrix Product State-Based Decoders For Stabilizer Codes Under Device Noise For Quantum Computing And Information Processing

(71) Applicant: Google LLC, Mountain View, CA (US)

(72) Inventors: Benjamin Villalonga Correa, Santa Monica, CA (US); Sergio Boixo Castrillo, Rancho Palos Verdes, CA (US); Michael Gabriel Newman, Palo Alto, CA (US)

(21) Appl. No.: 18/352,555

(22) Filed: Jul. 14, 2023

Related U.S. Application Data
(60) Provisional application No. 63/436,313, filed on Dec. 30, 2022.
(60) Provisional application No. 63/389,165, filed on Jul. 14, 2022.

(51) Int. Cl. G06N 10/70; G06N 10/40

(52) U.S. Cl. CPC G06N 10/70; G06N 10/40

(57) ABSTRACT

An enhanced matrix product state-based decoder is generated and employed to almost optimally detect and correct errors within a quantum computing and information processing system. The decoder takes as input a detector level error model that describes physical error channels and a set of error detections. This error model is improved using experimental data.

### PRIORITY CLAIM

This application claims priority to U.S. Provisional App. No. 63/389,165 (Attorney Docket No. GGLQ-136-P) having a filing date of Jul. 14, 2022, and entitled “MATRIX PRODUCT STATE-BASED DECODERS FOR STABILIZER CODES UNDER DEVICE NOISE FOR QUANTUM COMPUTING AND INFORMATION PROCESSING,” the contents of which are herein incorporated in their entirety. This application also claims priority to U.S. Provisional App. No. 63/436,313 (Attorney Docket No. GGLQ-136-P2) having a filing date of Dec. 30, 2022, and entitled “MATRIX PRODUCT STATE-BASED DECODERS FOR STABILIZER CODES UNDER DEVICE NOISE FOR QUANTUM COMPUTING AND INFORMATION PROCESSING,” the contents of which are herein incorporated in their entirety.

### FIELD

The present disclosure relates generally to quantum computing systems, and more particularly to decoders for quantum error correction.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for operating a quantum computing system (QCS). More specifically, the embodiments may be employed to detect and/or correct quantum errors occurring in the QCS. The method may include accessing an error model for the QCS. The error model may encode a set of error channels corresponding to a set of quantum error modes. A set of detected quantum errors may be accessed. The set of detected quantum errors may be encoded in a set of experimental measurements performed on the QCS. A tensor network may be generated. The tensor network may encode correlations between the quantum error modes of the set of quantum error modes and the detected quantum errors of the set of detected quantum errors. A matrix product state (MPS) may be generated based on the tensor network. To generate the MPS, the tensor network may be contracted via tensor contraction. A fault tolerant system having a decoder and error correction code (e.g., the code) may be generated for the QCS. At least the decoder of the fault tolerant system may be based on the MPS. That is, the MPS may affect the decoder of the fault tolerant system. The error correction code may be deployed to the QCS. Once deployed, the error correction code may be employed to detect an error occurring during a runtime of the QCS. The error correction code may be employed to correct the detected error.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2 depicts an example error model according to example embodiments of the present disclosure.

FIG. 3 depicts an example of local correlations between detectors within the error model.

FIG. 4 depicts an efficient contraction of the multi-dimensional tensor network of FIG. 2 into a one-dimensional matrix product state.

FIG. 5 depicts a constructive way to generate a matrix product state that approximates the joint probabilities according to various embodiments.

FIG. 6 depicts experimental data that indicates the convergence of the logical error probabilities as a function of bond distance.

FIG. 7 depicts a flow diagram of an example method for detecting and correcting quantum errors in a quantum computing system according to example embodiments of the present disclosure.

### DETAILED DESCRIPTION

Example aspects of the present disclosure are directed to enhanced systems and methods for calibrating composite quantum gates (e.g., two-qubit quantum gates) in a quantum computing system. Quantum gates can be the building blocks of quantum circuits implemented by quantum computing systems for quantum computation and quantum information processing. As used herein, the term “composite quantum gate” may refer to an object (e.g., a quantum circuit, a device, and/or structure) that performs operations on more than one input qubit (e.g., two qubits, three qubits). As used throughout, when discussing composite quantum gates, the terms “quantum gate” and simply “gate” may refer to a composite quantum gate. These two terms may additionally be employed to refer to single-qubit quantum gates (e.g., a quantum gate that performs operations on a single qubit). When distinction is required in the discussion, the terms composite gate and single-qubit gate may be employed. Various embodiments and physical implementations of composite quantum gates are discussed in “Demonstrating a Continuous Set of Two-Qubit Gates for Near-Term Quantum Algorithms,” by Foxen et al, Phys. Rev. Lett. 125, 120504 (2020), the contents of which are incorporated in their entirety. This incorporated paper may be found on the archive server https://arxiv.org/abs/2001.08343.

Quantum computing and information processing (QC&IP) may require that wavefunctions for the physical manifestations of information-encoding mechanisms (e.g., qubits) be isolated from the rest of the universe, e.g., the quantum states associated with a system's qubits are subject to decoherence and thus are relatively fragile. As such, the noise-threshold that a QC&IP system can tolerate is relatively low. Accordingly, quantum error correction (QEC), in some implementations, may be a critical feature of QC&IP systems. QEC mechanisms detect and correct errors within quantum signals, where the signals are encoded in the “interference” patterns of the coherent qubits. That is, when a QEC-enabled system detects an error, rather than simply re-running the calculation, the system may deploy mechanisms to correct the detected error. QEC codes may provide such a mechanism. Classical error correction codes (e.g., Hamming codes) typically encode redundant bits of information in the signal being processed. This redundant information enables the reconstruction of classical information that becomes corrupted while storing, transmitting, and/or processing of signal.

QEC codes are somewhat analogous to classical error correcting codes. However, and in contrast to encoding redundant information in “extra” bits, QEC encoding may “spread” or distribute information over multiple qubits via entanglement of the qubits' quantum states. The act of “spreading” the signal (e.g., encoding information to be processed) over multiple qubits is generally referred to as encoding. The act of extracting the information that is spread over multiple qubits is generally referred to as decoding. Accordingly, in order to build an error corrected quantum computer, encoding and decoding are critical aspects in implementing QEC protocols.

A quantum decoder is generally responsible for inferring whether a logical error has occurred in the QC&IP system. More specifically, a decoder takes as input a certain set of experimental measurements and an error model. The decoder may be (or generate) a probabilistic description of how errors are likely to occur in the QC&IP system. The probabilistic description may be based on the set of experimental measurements and the error model. A discrete element of the set of experimental measurements may be referred to as a detection event and/or a detector.

Example embodiments are directed towards enhanced decoders that employ tensor contractions to generate an almost exact probabilistic description of how errors are likely to occur in the QC&IP system. Mapping the set of detection events and the error model to a description of errors may be computationally complex. For example, the computational resources required to analytically compute this mapping scales exponentially as the size of the QEC code grows linearly.

Rather than directly computing this mapping, conventional decoders often employ heuristics to generate an approximate mapping. Such heuristics often result in less-than-ideal QEC performance. For example, conventional decoders may attempt to generate a mapping by searching for plausible error configurations consistent with the set of experimental measurements. Such conventional decoders generate a mapping via graph matching techniques. These conventional decoders generate only an approximate mapping because only a subset of the error configurations consistent with the set of experimental measurements are mapped.

In contrast to conventional decoders, example embodiments of the present disclosure employ tensor networks, and more specifically, matrix product states. As discussed below, the example embodiments generate and evaluate tensor networks via tensor contraction (e.g., contracting one or more indexes in a tensor and/or tensor product). The embodiments include matrix product state decoders that can decode almost optimally. A matrix product state decoder can also serve as a framework for approximate decoders. The enhanced decoders take as input a detector level error model that describes physical error channels. This error model can be improved using experimental data.

Aspects of the present disclosure provide a number of technical effects and benefits. For instance, the enhanced decoders can map a detector level error model that describes physical error channels and what measurements they affect to a tensor network. Conventional decoders have only successfully done so on finely tuned error models. The resulting tensor networks can be evaluated (via tensor contraction) almost exactly by an enhanced algorithm. This algorithm works by mapping the irregular tensor network contraction to an efficient matrix product state (MPS) evolution. An enhanced MPS includes an ansatz (e.g., an initial educated guess) to encode the probability distribution associated with detectors (e.g., experiment measurements or detection events) and logical bit information. The ansatz may be updated (e.g., trained) via machine learning techniques. Once trained, the ansatz may be employed to efficiently evaluate the likelihood of the different logical measurement outcomes. The likelihood (or probabilities) of different logical measurement outcomes can then be used to determine whether a logical error has occurred. As an input, the decoder takes an error model (e.g., encoding the probabilities of the different measurement outcomes). The error model may be iteratively updated (or trained) by making use of additional experimental data and the MPS ansatz.

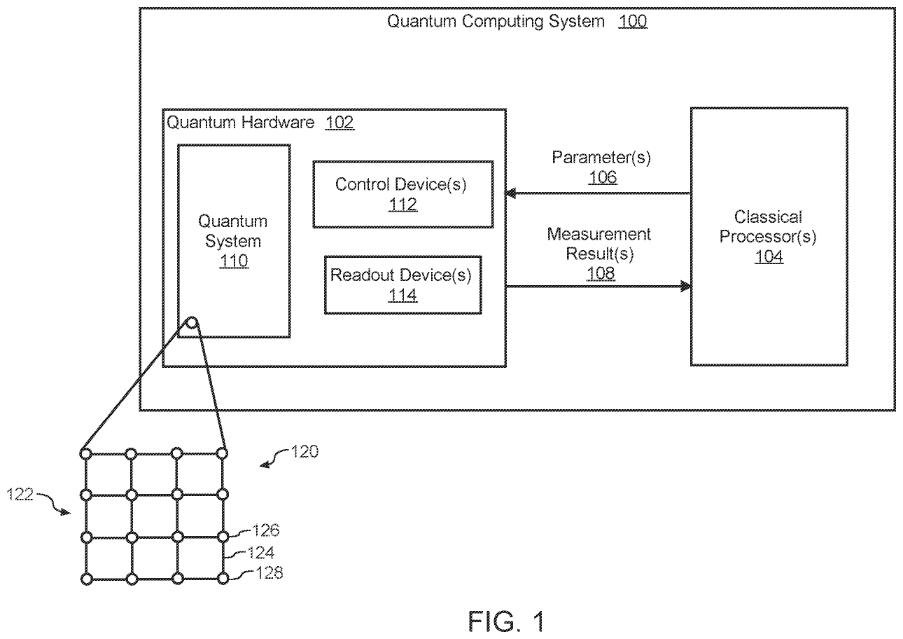

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

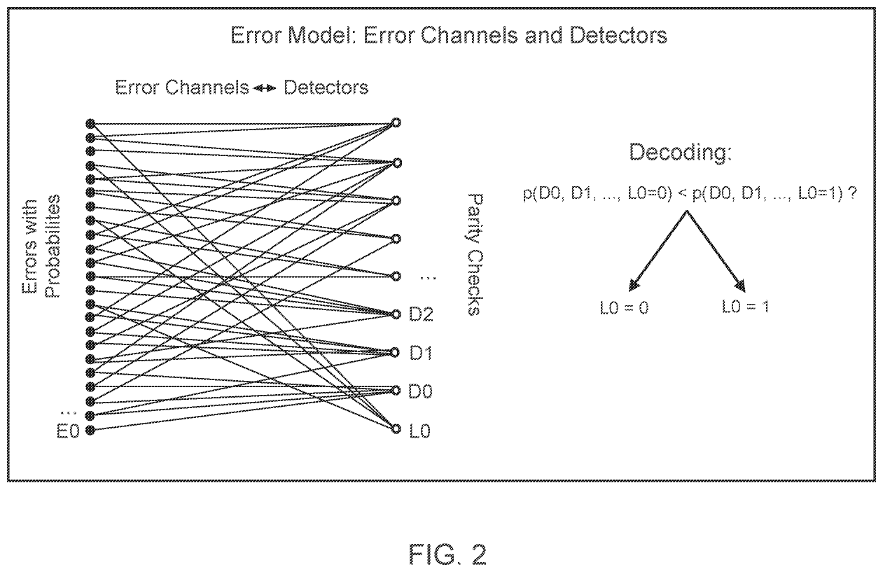

FIG. 2 depicts a graphical depiction of an example error model 200 according to example embodiments of the present disclosure. As shown in FIG. 2, the error model 200 may be encoded via a bipartite graph 210 that includes error channels 220 and detectors 230. The error channels 220 include the graph nodes on the left side of the graph 210 and the detectors 230 include the graph nodes on the right side of the graph 200. The error channels 220 may be physical error channels. The error model 200 may be a detector-level error model that encodes physical error channels 220 (e.g., corresponding to the left-hand side nodes of the bipartite graph). The error model 200 may additionally encode what detectors 230 each of the error channels affects 220 (e.g., the corresponding nodes of the right-hand side of the bipartite graph). The bipartite graph 200 may be referred to as a circuit-level Tanner graph.

As indicated in FIG. 2, each error channel 220 (e.g., the nodes or vertices on the left-hand side) may have an associated probability. The detectors 230 (e.g., the right-hand side nodes (or vertices)) are indexed as: D0-DN correspond to detectors (or measurement) variables. Thus, the right-hand side nodes (or vertices) indexed as: D0-DN may be referred to as detector bits. The right-hand side node(s) indexed as L0-LM correspond to a logical bit variable. The right-hand side node indexed as L0-LM may be referred to as logical bits. The logical bit variable may change value by activating error channels connected to it. Each detector or logical bit changes value if an odd number of neighboring error channels is activated.

The right-hand side of FIG. 2 shows a decoding process 240. More particularly, the sum of the probabilities of all possible error configurations may consistent with some detector and logical bit outcomes is equal to the likelihood of that configuration. By comparing the likelihoods (e.g., comparison of likelihoods 250) corresponding to all possible outcomes of the logical measurements, the most likely logical bit possibility may be estimated. Thus, whether a logical error occurred with certain confidence may be inferred. The bipartite graph 210 in FIG. 2 may be representative of a multi-dimensional tensor network. Calculating this exponentially large sum of probabilities involves contracting the underlying tensor network (e.g., via tensor contraction). To contract this tensor network efficiently, a protocol may be employed. The protocol converts the multi-dimensional tensor network of FIG. 2 into a circuit that corresponds to the evolution of a one-dimensional tensor network, referred to as a matrix product state (MPS) or a tensor train.

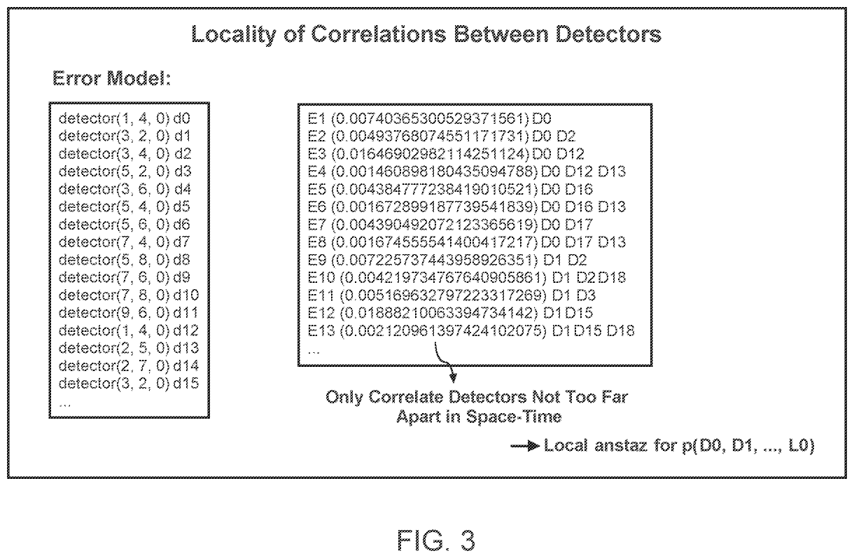

FIG. 3 depicts an example of local correlations between detectors within the error model. The locality of the correlations between detectors indicate a finite maximum bond dimension that is employed to parameterize the tensor network contraction, as discussed below.

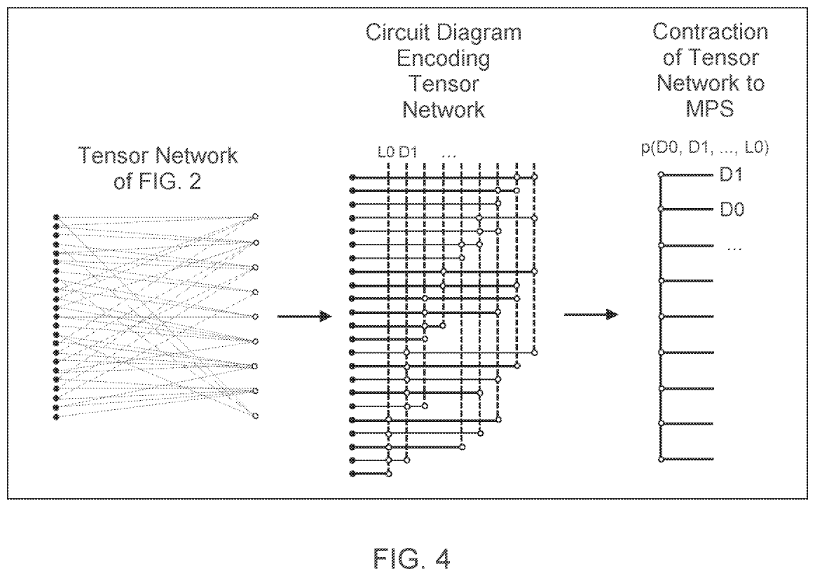

Turning attention to FIG. 4, which depicts the efficient contraction of the multi-dimensional tensor network of FIG. 2 (e.g., graph 210) into a one-dimensional matrix product state (MPS) 460. The circuit diagram 410 of FIG. 4 encodes the tensor network (e.g., graph 210 of FIG. 2). In the circuit diagram 410, the left-hand side nodes of graph 210 correspond to the error channels 420 of the tensor network of FIG. 2, while the vertical lines represent the detector bits and the logical bit of the underlying tensor network, which are labeled with L and D to indicate logical bits and detector bits corresponding. The set of error channels 420 form a one-dimensional MPS 460 that can now be evolved from left to right by contracting it with detectors. By setting a maximum bond dimension that the evolution of the MPS 460 is allowed to carry through the contraction, the tensor network may be approximately evaluated given a set of detection events and logical bit value. In practice, the bond dimension required for small to intermediate size error correcting codes is not too large.

A related decoding technique uses the fact that the contraction of this tensor network yields an MPS over the detector and logical bit variables before these are assigned their corresponding values. The MPS can be directly used over these variables as an ansatz for their joint probability distribution. It is also possible to train this ansatz to match experimental data.

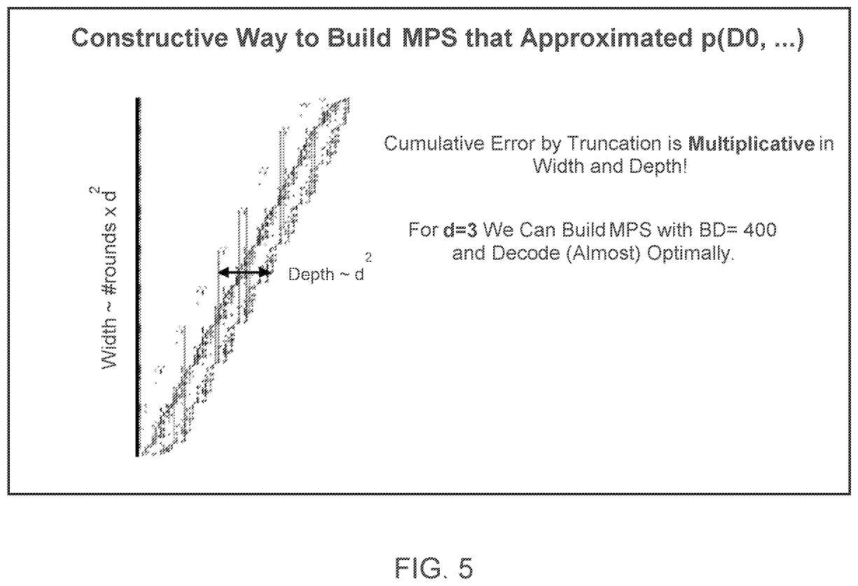

FIG. 5 depicts a constructive way to generate a matrix product state that approximates the joint probabilities according to various embodiments. As such, the embodiments may be employed to implement a close-to-optimal (e.g., an enhanced) decoder that maps a prior distribution to a tensor network. Various embodiments of the prior distribution are discussed in “Suppressing Quantum Error by Scaling a Surface Code Logical Qubit” by Acharya et al., arXiv:2207.06431v2 [quant-ph] (July 2021), the contents of which are incorporated in their entirety. This incorporated paper may be found on the archive server https://arxiv.org/abs/2207.06431v2.

Given a configuration of detection events and a choice of logical frame change, the contraction of this tensor network may be employed to estimate the joint probabilities. It does so by summing the probabilities of all error configurations compatible with the set of detection events and logical frame change considered. This decoder guesses the more plausible logical frame change by comparing the likelihood of both outcomes. For more than a single logical qubit, the decoder guesses the most plausible logical frame change among all outcomes, of which there are 2(#logical qubits). In contrast to conventional decoders, the embodiments use device level noise as an input correlations rather than gate-level noise.

The contraction complexity of the resulting tensor network grows exponentially in d², where d is the distance of the code. In practice, the contraction is approximated via matrix product state (MPS) evolution (as shown in FIGS. 4-5) with a finite maximum bond dimension, χ. The complexity of this approximate contraction grows with χ³.

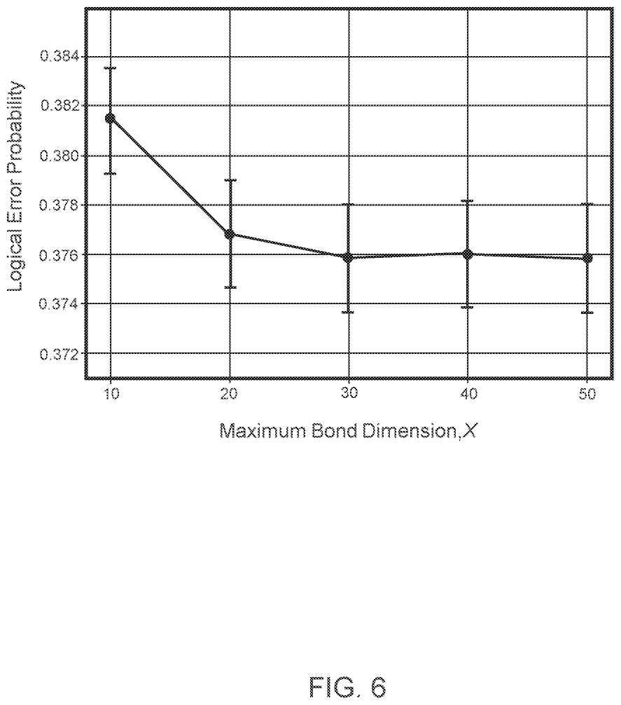

FIG. 6 depicts experimental data that indicates the convergence of the logical error probabilities as a function of bond distance. That is, the plot 600 of FIG. 6 shows the convergence of the logical error probabilities, as a function of the parameter χ. As shown in FIG. 6, the convergence 610 of plot 600 occurs approximately at χ=30. This convergence 610 is accomplished by contraction the tensor network in order from the error channel tensors towards the detector tensors. Accordingly, in various embodiments, the bond parameter value of χ=30 may be employed to decode errors.

To generate the plot 600 of FIG. 6, a logical error probability of a distance-5, Z-basis, 25-round experiment with 50,000 shots is used as a function of the maximum bond dimension χ used in the tensor net-work contraction. Error bars denote standard error of the mean. It is observed that the logical error probability stabilizes at χ=30.

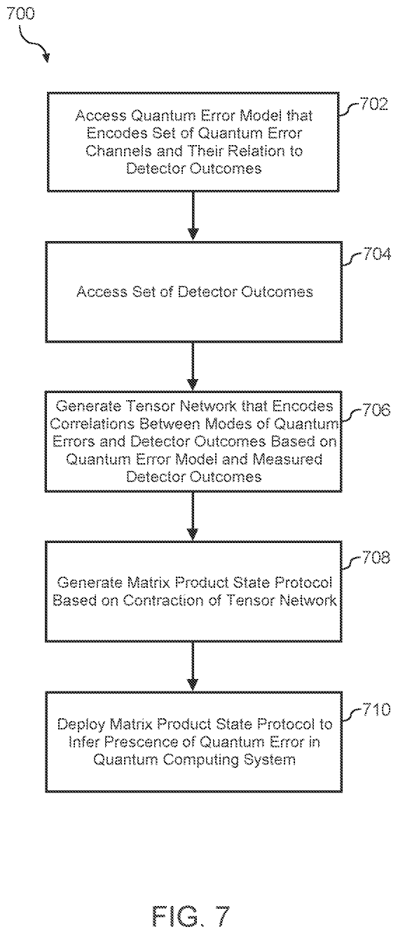

FIG. 7 depicts a flow diagram of an example method 700 for detecting and correcting quantum errors in a quantum computing system according to example embodiments of the present disclosure. Method 700 begins at block 702, where a quantum error model may be accessed. The quantum error model may encode a set of quantum error channels. The quantum error model may additionally encode one or more relations of the quantum error channels to detector outcomes. At block 704, a set of detector outcomes is accessed. The set of detected quantum errors may include a set of experimental measurements. At block 706, a tensor network is generated. The tensor network may encode correlations between modes of quantum errors and detector outcomes. The correlations may be based on the quantum error model and the measured detector outcomes. At block 708, a matrix product state (MPS) protocol may be generated based on a contraction of the tensor network. At block 710, the MPS protocol may be deployed to infer the presence of one or more quantum errors in a quantum computing system.

### Additional Embodiments

One example aspect of the present disclosure is directed to a method for operating a quantum computing system (QCS). More specifically, the embodiments may be employed to detect and/or correct quantum errors occurring in the QCS. The method may include accessing an error model for the QCS. The error model may encode a set of error channels corresponding to a set of quantum error modes. A set of detected quantum errors may be accessed. The set of detected quantum errors may be encoded in a set of experimental measurements performed on the QCS. A tensor network may be generated. The tensor network may encode correlations between the quantum error modes of the set of quantum error modes and the detected quantum errors of the set of detected quantum errors. A matrix product state (MPS) may be generated based on the tensor network. To generate the MPS, the tensor network may be contracted via tensor contraction. A fault tolerant system having a decoder and error correction code (e.g., the code) may be generated for the QCS. At least the decoder of the fault tolerant system may be based on the MPS protocol. That is, the MPS protocol may affect the decoder of the fault tolerant system. The error correction code may be deployed to the QCS. Once deployed, the error correction code may be employed to detect an error occurring during a runtime of the QCS. The error correction code may be employed to correct the detected error.

In at least one embodiment, the MPS protocol may be deployed to infer an error occurring during a runtime of the QCS. The MPS protocol may be deployed to correct an error occurring during a runtime of the QCS. The MPS protocol may be generated by contracting the tensor network. Contracting the tensor work may include summing probabilities associated with a subset of the error modes that are compatible with the set of detected quantum errors. Generating the MPS protocol may be parameterized by a maximum bond dimension. The maximum bond dimension may be set to a value of approximately 30. The MPS protocol may be generated by employing an ansatz to encode a probability distribution associated with the set of detected quantum errors and logical bit information. The method may further include training the ansatz.

In various embodiments, the method further includes encoding the error model and the set of detected quantum errors in a bipartite graph. A circuit diagram may be generated. The bipartite graph may be generated based on the generated circuit diagram. Generating the circuit diagram may be based on the bipartite graph. The MPS protocol may be generated based on the circuit diagram.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc. . . .

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for operating a quantum computing system (QCS), the method comprising:
accessing an error model for the QCS, wherein the error model encodes a set of error channels and a relation to detector outcomes;
accessing a set of measured detector outcomes;
generating a tensor network that encodes correlations between the quantum error modes of the set of quantum error modes and the set of measured detector outcomes; and
generating a matrix product state (MPS) protocol based on the tensor network.

2. The method of claim 1, further comprising:
deploying the MPS protocol to detect an error occurring during a runtime of the QCS.

3. The method of claim 2, further comprising:
deploying the MPS protocol to correct an error occurring during a runtime of the QCS.

4. The method of claim 1, wherein the MPS protocol is generated by contracting the tensor network.

5. The method of claim 4, wherein contracting the tensor work includes summing probabilities associated with a subset of the error modes that are compatible with the set of detected quantum errors.

6. The method of claim 1, wherein generating the MPS protocol is parameterized by a maximum bond dimension.

7. The method of claim 6, wherein the maximum bond dimension is set to a value of approximately 30.

8. The method of claim 1, wherein the MPS protocol is generated by employing an ansatz to encode a probability distribution associated with the set of detected quantum errors and logical bit information.

9. The method of claim 8, further comprising:
training the ansatz.

10. The method of claim 1, further comprising:
generating a circuit diagram based on the error model and the set of detected quantum errors;
generating a bipartite graph based on the circuit diagram; and
generating the MPS protocol based on at least one of the circuit diagram and the bipartite graph.

11. A system, comprising:
one or more memory devices, the one or more memory devices storing computer-readable instructions that when executed by the one or more processors cause performance of operations comprising:
accessing an error model for a quantum computing system (QCS), wherein the error model encodes a set of error channels corresponding to a set of quantum error modes;
accessing a set of detected quantum errors encoded in a set of experimental measurements performed on the QCS;
generating a tensor network that encodes correlations between the quantum error modes of the set of quantum error modes and the detected quantum errors of the set of detected quantum errors;
generating a matrix product state (MPS) protocol based on the tensor network; and
computing a likelihood that a logical error has occurred by employing the MPS protocol to generate an error corrected QCS.

12. The system of claim 11, wherein the operations further comprise:
deploying the MPS protocol to detect an error occurring during a runtime of the QCS.

13. The system of claim 11, wherein the operations further comprise:
deploying the MPS protocol to correct an error occurring during a runtime of the QCS.

14. The system of claim 11, wherein the MPS protocol is generated by contracting the tensor network.

15. The system of claim 14, wherein contracting the tensor network includes summing probabilities associated with a subset of the error modes that are compatible with the set of detected quantum errors.

16. The system of claim 11, wherein generating the MPS protocol is parameterized by a maximum bond dimension.

17. The system of claim 16, wherein the maximum bond dimension is set to a value of approximately 30.

18. The system of claim 11, wherein the operations further comprise:
generating a circuit diagram based on the error model and the set of detected quantum errors;
generating a bipartite graph based on the circuit diagram; and
generating the MPS protocol based on at least one of the circuit diagram and the bipartite graph.

19. One or more non-transitory computer-readable media that store instructions for operating a quantum computing system (QCS), and when the instructions are executed by one or more processors, cause the one or more processors to perform operations comprising:
accessing an error model for the QCS, wherein the error model encodes a set of error channels and a relation to detector outcomes;
accessing a set of measured detector outcomes;
generating a tensor network that encodes correlations between the quantum error modes of the set of quantum error modes and the set of measured detector outcomes; and
generating a matrix product state (MPS) protocol based on the tensor network.

20. The computer-readable media of claim 19, wherein the operations further comprise:
generating a circuit diagram based on the error model and the set of detected quantum errors;
generating a bipartite graph based on the circuit diagram; and
generating the MPS protocol based on at least one of the circuit diagram and the bipartite graph.
